(19) United States
(12) Patent Application Publication
(10) Pub. No.: US 2006/0098091 A1
(43) Pub. Date: May 11, 2006

(54) Surveillance system for remotely controlling camera through monitor and method thereof

(75) Inventor: Doo-hwan Chun, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/981,476

(22) Filed: Nov. 5, 2004

(51) Int. Cl. H04N 7/18

(52) U.S. Cl. 348/143

(57) ABSTRACT

A surveillance system for controlling a camera at a remote location through a monitor. Transmission and reception of an image signal and a power application between a camera and a monitor are accomplished through a single cable. A monitor, connected to the camera through the cable, applies power to the camera through the cable and transmits a camera control signal corresponding to a camera control command to the camera, to control a field of vision of a photographed image corresponding to the camera control signal. Accordingly, the camera is controllable at a location remote from the monitor and the surveillance effect is elevated.

### CROSS-REFERENCE TO RELATED APPLICATIONS

Not Applicable

### BACKGROUND OF THE INVENTION

1. Field of the Invention

The present invention relates to a surveillance system for controlling a camera at a remote location and a method thereof. More specifically, the present invention relates to a surveillance system for applying power between a monitor and a camera through a single registered jack (RJ)-45 cable, communicating data, and controlling the camera at a remote location using a remote controller, and a method thereof.

2. Description of the Related Art

Typically, a surveillance system includes at least one camera, a monitor displaying an image received from the camera, and a remote controller controlling the monitor. The monitor of the surveillance system receives and displays image signals of the cameras. A plurality of monitors may be assembled in one place, or a screen of a single monitor may be split for displaying multiple images.

A new surveillance system has been developed, which is capable of applying a power using an image signal transmission and reception lines between the monitor and the camera so as to solve a problem that the camera is frequently installed outside where it is difficult for the camera to be applied with the power. The transmission and reception lines adopt a RJ-45 (registered jact-45) cable. The RJ-45 cable, which features eight pins, has additional lines in addition to lines for reception and transmission of image and voice signals and power application.

However, if a user observing through the monitor intends to control panning (horizontal rotation), tilting (vertical rotation), and zooming (image resizing), which are referred to as P/T/Z, the conventional surveillance system has a disadvantage that additional lines for the P/T/Z control need to be connected to the camera and a P/T/Z controller is required separately.

### SUMMARY OF THE INVENTION

To address the above and/or other disadvantages of the conventional arrangement, an aspect of the present invention is to provide a surveillance system which controls a field of vision of a plurality of cameras scattered at remote locations through a monitor or a monitor remote controller by using additional lines of a conventional transmission and reception cable without having to add a P/T/Z controller and a control line, and a method thereof.

To achieve the above and/or other aspects of the present invention, the surveillance system comprises a camera for controlling a field of vision of a photographed image corresponding to a camera control signal, and a monitor connected to the camera through a cable for applying power to the camera through the cable and transmitting the camera control signal corresponding to a camera control command to the camera.

The surveillance system further comprises a remote controller for transmitting the camera control command to the monitor, to control at least one of panning, tilting, or zooming of the camera.

The monitor comprises a light receiver for receiving the camera control command, a monitor controller for transmitting the camera control signal corresponding to the camera control command, a monitor interface for providing an interface so that the transmitted camera control signal is recognizable by the camera, and a monitor input and output (I/O) terminal for connecting with the cable so that the camera control signal processed in the monitor interface is transmitted through the cable.

The monitor interface may comply with recommended standard RS-485. The monitor I/O terminal may be a registered jack RJ-45 module.

The monitor further comprises a monitor signal processor for converting an image signal transmitted from the camera to a displayable signal form, and a display for displaying on a screen the image signal converted in the monitor signal processor. The monitor may further comprise a monitor power unit for receiving power from outside the monitor and applying the power to the camera through the cable. The monitor power unit may employ a switching mode power supply (SMPS).

The camera may comprise a photographing unit for forming an optical image of an external object and photoelectrically converting the optical image to an electric image signal, a camera I/O terminal for receiving the camera control signal through the cable, a camera interface for providing an interface so that the received camera control signal is recognizable by the camera, and a camera controller for controlling the photographing unit corresponding to the camera control signal.

The camera interface may comply with the RS-485. The camera I/O terminal may be the RJ-45 module.

The camera may further comprise a camera signal processor for processing and transmitting the image signal photographed in the photographing unit to the camera interface. The processed image signal is transmitted to the monitor through the cable.

The camera further comprises a camera power unit for converting the power applied through the cable to power suitable for the camera. The cable may be an RJ-45 cable.

The method of controlling a camera of an surveillance system which performs transmission and reception of an image signal and a power application between a camera and a monitor through a single cable, may comprise receiving a camera control command through the monitor, transmitting a camera control signal from the monitor through the cable corresponding to the camera control command, and controlling a field of vision of a photographed image of the camera in response to the camera control signal.

The camera control signal may control at least one of panning, tilting, and zooming of the camera.

The transmitting of the camera control signal through the cable may comprise receiving the camera control command, generating the camera control signal corresponding to the camera control command, interfacing the camera control signal to be received by the camera through the cable, and transmitting the interfaced camera control signal through the cable.

The interfacing of the camera control signal to be received through the cable may adopt a recommended standard RS-485. The transmitting of the interfaced camera control signal through the cable may use a registered jack RJ-45 module.

The transmitting of the camera control signal from the monitor through the cable may further comprise converting the image signal received from the camera to a displayable signal form, and a displaying the converted image signal on a screen.

The controlling of the camera may further comprise forming an optical image of an external object and photoelectrically converting the optical image to an electric image signal, receiving the camera control signal through the cable, providing an interface so that the received camera control signal is recognizable by the camera, and controlling the forming of the optical image corresponding to the camera control signal.

The camera interfacing may adopt the RS-485. The receiving of the camera control signal may be accomplished through the RJ-45 module.

The controlling of the camera may further comprise transmitting the photographed image signal to a camera interface, and an image signal transmission step of transmitting the processed image signal to the monitor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a surveillance system according to an embodiment of the present invention;

FIG. 2 is a block diagram of a monitor shown in FIG. 1;

FIG. 3 is a block diagram of a camera shown in FIG. 1;

FIG. 4 is a flowchart of an operation of the surveillance system according to an embodiment of the present invention;

FIG. 5 is a flowchart illustrating the transmitting of the camera control signal of FIG. 4; and

FIG. 6 is a flowchart of controlling the camera of FIG. 4.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

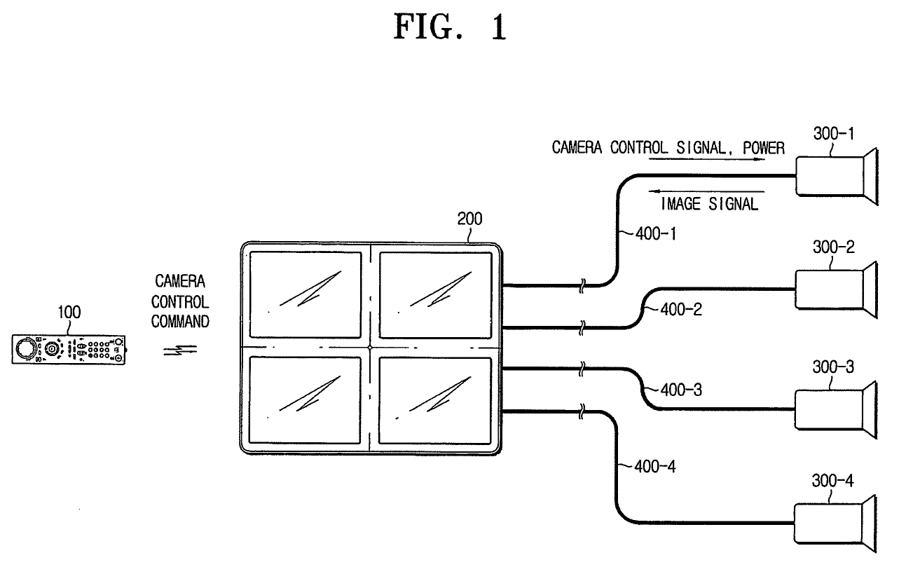

FIG. 1 illustrates a surveillance system according to an embodiment of the present invention. The surveillance system includes a remote controller 100, a monitor 200, at least one camera 300-1, 300-2, 300-3 and 300-4, and RJ-45 cables 400-1, 400-2, 400-3 and 400-4, respectively.

The remote controller 100 comprises a key (not numbered) corresponding to a camera control command for controlling a respective field of vision of the cameras 300-1 to 300-4 installed at remote locations, that is, for controlling panning, tilting, and zooming (P/T/Z) of the cameras 300-1 to 300-4. The remote controller 100 transfers the camera control command in accordance with the input of the key. The camera control command contains information on the cameras 300-1 to 300-4 to be controlled.

The monitor 200 is supplied with external power and transfers the power to the cameras 300-1 to 300-4 using the RJ-45 cables 400-1 to 400-4, and receives and displays image signals photographed by the cameras 300-1 to 300-4 through the RJ-45 cables. Upon receiving the camera control command, the monitor 200 generates and transmits a camera control signal to a corresponding camera 300-1 to 300-4.

The cameras 300-1 to 300-4 are installed at locations to be monitored. The cameras 300-1 to 300-4 operate with the applied power and transmit photographed image signals to the monitor 200 through the RJ-45 cables 400-1 to 400-4. Upon receiving the camera control command, the cameras 300-1 to 300-4 control the field of vision of the image, that is, the P/T/Z.

Each of the RJ-45 cables 400-1 to 400-4 has eight pins and includes lines for receiving and transmitting the image signals, the camera control signal, and the power.

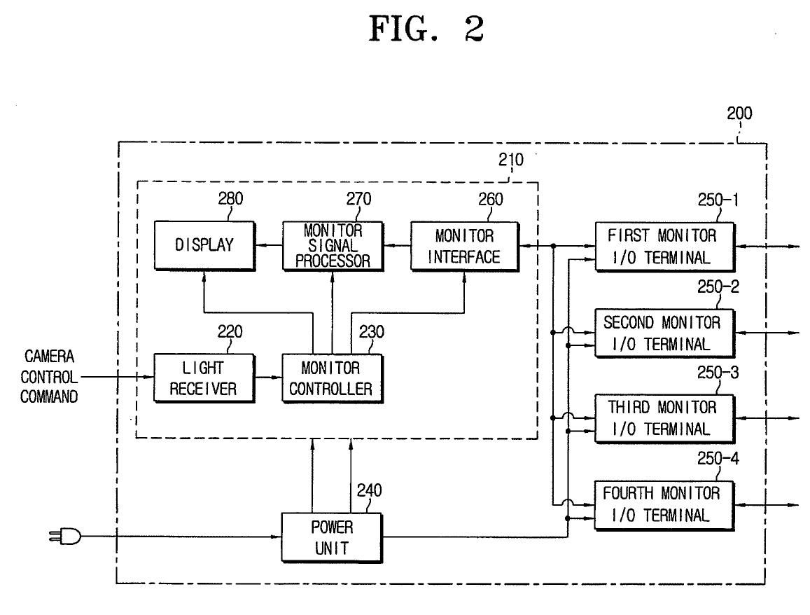

FIG. 2 is block diagram of the monitor 200 of FIG. 1. Referring to FIG. 2, the monitor 200 includes a power unit 240, a monitor circuit unit 210, and monitor input and output (I/O) terminals 250-1, 250-2, 250-3 and 250-4. The monitor circuit unit 210 includes a light receiver 220, a monitor controller 230, a monitor interface 260, a monitor signal processor 270, and a display 280.

The power unit 240 is supplied with the external power and applies the power to the monitor circuit unit 210. The power unit 240 applies the power to the cameras 300-1 to 300-4 through the monitor I/O terminals 250-1 to 250-4 and the cables 400-1 to 400-4, respectively.

The light receiver 220 receives the camera control command of an infrared signal form from the remote controller 100. The camera control command is to control the P/T/Z of one of the cameras 300-1 to 300-4.

The monitor controller 230 controls the monitor interface 260, the monitor signal processor 270, and the display 280. When the monitor 200 is applied with the external power, the monitor controller 230 scans the cameras 300-1 to 300-4 being connected and records in a certain memory (not shown) a number of the connected cameras 300-1 to 300-4 and the P/T/Z control feasibility, i.e., whether a respective camera is adapted for P/T/Z control. Upon receiving the camera control command, if the camera 300-1 to 300-4 corresponding to the camera control command is controllable with respect to the P/T/Z, the monitor controller 230 generates and transmits the camera control signal to the monitor interface 260.

The monitor interface 260 provides an interface so that the monitor 200 and each camera 300-1 to 300-4 may effectively communicate with each other through a respective one of the RJ-45 cables 400-1 to 400-4. Advantageously, the monitor interface complies with a recommended standard RS-485. The interfaced camera control signal is transmitted to a respective monitor I/O terminal 250-1 to 250-4 connected to a respective camera 300-1 to 300-4 corresponding to the camera control command.

The monitor I/O terminals 250-1 to 250-4 are RJ-45 connectors and connected to a respective one of the RJ-45 cables 400-1 to 400-4. The monitor I/O terminals 250-1 to 250-4 output the signal transmitted from the monitor 200 to the RJ-45 cables 400-1 to 400-4, respectively, and receive the image signals from the cameras 300-1 to 300-4, respectively.

The monitor signal processor 270 processes the image signals, which are received through the monitor I/O terminals 300-1 to 300-4 and interfaced to be recognizable by the monitor 200, to a displayable image signal. The display 280 displays the image signal received from the monitor signal processor 270.

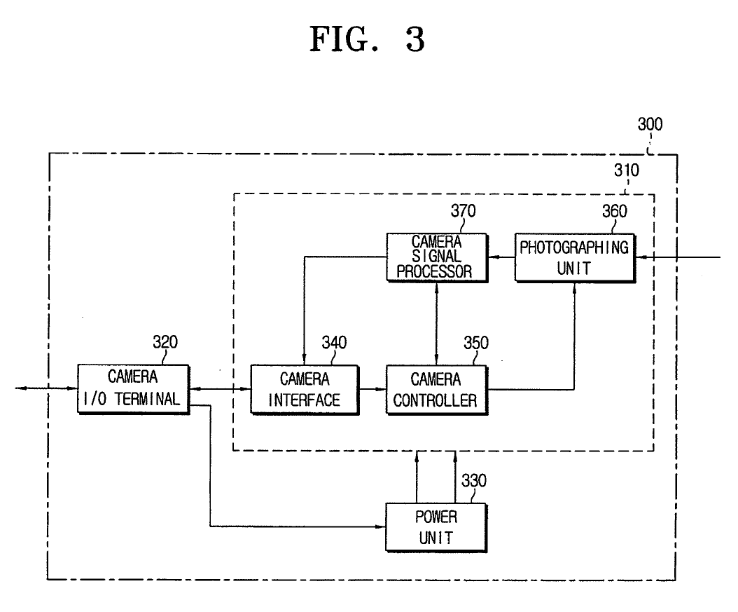

FIG. 3 is a block diagram of one of the cameras 300-1 to 300-4 of FIG. 1, which for simplicity of explanation will be referred to as a camera 300. Referring to FIG. 3, the camera 300 includes a camera I/O terminal 320, a camera power unit 330, and a camera circuit unit 310. The camera circuit unit 310 includes a camera interface 340, a camera controller 350, a photographing unit 360, and a camera signal processor 370.

The camera I/O terminal 320 receives the camera control signal from the monitor 200 through a respective one of the RJ-45 cables 400-1 to 400-4 and transmits the received signal to the camera interface 340. In the description of operation of the camera 300, the respective cable will be referred to simply as cable 400. The camera I/O terminal 320 is supplied with power through the cable 400.

The power unit 330 converts the power supplied through the cable 400 to a power suitable for the camera 300 and applies the converted power to the camera circuit unit 310. The camera circuit unit 310 operates by the applied power.

The camera interface 340 provides an interface enabling the monitor 200 and the camera 300 to effectively communicate with each other through the RJ-45 cable 400. Advantageously, the interface complies with the RS-485. The camera controller 350 controls a field of vision of the photographing unit 360, that is, controls the P/T/Z upon receiving the camera control signal interfaced to be recognizable by the camera controller 350.

The photographing unit 360 forms and photoelectrically converts an optical image of an external object to an electric image signal. The camera signal processor 370 processes and transmits the image signal converted in the photographing unit 360 to the camera interface 340.

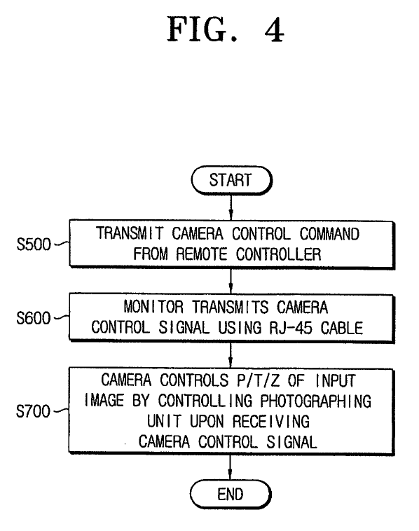

FIG. 4 is a flowchart of an operation of the surveillance system for controlling the camera at a remote location through the monitor according to an embodiment of the present invention. Referring to FIG. 4, a camera control command is transmitted from the remote controller 100 at operation S500. Upon receiving the camera control command, the monitor 200 transmits the camera control signal to the camera 300 through the RJ-45 cable 400 at operation S600. Upon receiving the camera control signal, the camera 300 controls the P/T/Z of the photographing unit 360 at operation S700.

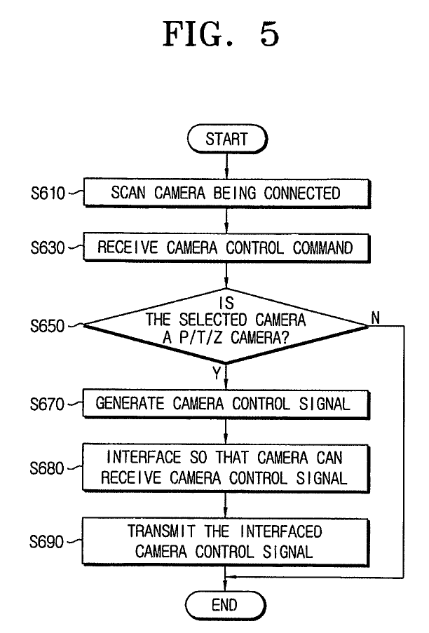

FIG. 5 is a flowchart of operations for transmitting the camera control signal of FIG. 4. Referring to FIG. 5, a type and a number of the cameras 300 being connected are scanned at operation S610. When a camera control command containing the information on the camera 300 to be controlled at operation S630 is received, a determination is made whether the camera 300 is controllable with respect to the PIT/Z at operation S650. If the camera 300 to be controlled does not have a P/T/Z control function, the camera control signal is not transmitted and the control operation is terminated. If the camera 300 has the P/T/Z control function, the camera controller 350 generates the camera control signal at operation S670. The generated camera control signal is interfaced to be received by the camera 300 at operation S680, and transmitted through the RJ-45 cable 400 at operation S690.

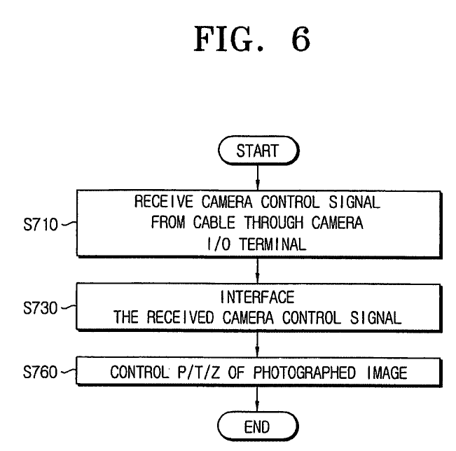

FIG. 6 is a flowchart of operations for controlling the camera 300 of FIG. 4. Referring to FIG. 6, the camera 300 receives the camera control signal from the RJ-45 cable 400 through the camera I/O terminal 320 at operation S710. The received camera control signal is interface at operation S730 and transmitted to the camera controller 350. The camera controller 350 controls the P/T/Z of the photographing unit 360 at operation S760.

As explained above, the field of vision of the camera 400 is controllable at the remote location through the monitor 200.

In light of the foregoing, a plurality of the cameras scattered at the remote locations are controllable in one place by using the monitor, without having to manually move each of the cameras. If a change of the field of vision of the cameras is required during the surveillance through the monitor, the control of the field of vision is immediately feasible and thus, the surveillance effect is elevated. Since the existing lines are utilized, additional cost for installing separate lines is not required.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A surveillance system comprising:
a camera which controls a field of vision of a photographed image corresponding to a camera control signal; and
a monitor connected to the camera through a cable which applies power to the camera through the cable and transmits the camera control signal corresponding to a camera control command to the camera.

2. The surveillance system of claim 1, further comprising a remote controller which transmits the camera control command to the monitor.

3. The surveillance system of claim 1, wherein the camera control signal controls at least one of panning, tilting, or zooming of the camera.

4. The surveillance system of claim 1, wherein the monitor comprises:
a light receiver which receives the camera control command;
a monitor controller which transmits the camera control signal corresponding to the camera control command;
a monitor interface which interfaces the transmitted camera control signal to be recognizable by the camera; and
a monitor input and output (I/O) terminal which connects with the cable so that the camera control signal processed in the monitor interface is transmitted through the cable.

5. The surveillance system of claim 4, wherein the monitor interface complies with recommended standard RS-485.

6. The surveillance system of claim 4, wherein the monitor I/O terminal is a registered jack RJ-45 module.

7. The surveillance system of claim 4, further comprising:
a monitor signal processor which converts an image signal transmitted from the camera to a displayable signal form; and
a display which displays an image corresponding to the converted image signal on a screen.

8. The surveillance system of claim 4, further comprising a monitor power unit which supplies external power to the camera through the cable.

9. The surveillance system of claim 8, wherein the monitor power unit employs a switching mode power supply (SMPS).

10. The surveillance system of claim 1, wherein the camera comprises:
a photographing unit which forms an optical image of an external object and photoelectrically converts the optical image to an electric image signal;
a camera I/O terminal which receives the camera control signal through the cable;
a camera interface which provides an interface so that the received camera control signal is recognizable by the camera; and
a camera controller which controls the photographing unit corresponding to the camera control signal.

11. The surveillance system of claim 10, wherein the camera interface complies with recommended standard RS-485.

12. The surveillance system of claim 10, wherein the camera I/O terminal is an RJ-45 module.

13. The surveillance system of claim 10, further comprising a camera signal processor which processes and transmits the image signal photographed in the photographing unit to the camera interface, wherein the processed image signal is transmitted to the monitor through the cable.

14. The surveillance system of claim 10, further comprising a camera power unit which converts the power applied through the cable to a power suitable for the camera.

15. The surveillance system of claim 1, wherein the cable is an RJ-45 cable.

16. A method of controlling a camera of an surveillance system which receives and transmits an image signal and a power application between a camera and a monitor through a single cable, the method comprising:
receiving a camera control command through the monitor;
transmitting a camera control signal through the cable corresponding to the camera control command; and
controlling a field of vision of a photographed image corresponding to the camera control signal.

17. The method of claim 16, further comprising:
controlling at least one panning, tilting, or zooming of the camera in response to the camera control signal.

18. The method of claim 16, wherein the transmitting of the camera control signal through the cable comprises:
generating the camera control signal corresponding to the camera control command;
interfacing the camera control signal to be received by the camera through the cable; and
transmitting the interfaced camera control signal through the cable.

19. The method of claim 18, further comprising:
interfacing of the camera control signal using a recommended standard RS-485.

20. The method of claim 18, further comprising:
transmitting of the interfaced camera control signal using a registered jack RJ-45 module.

21. The method of claim 18, further comprising:
converting the image signal received from the camera to a displayable signal form; and
displaying an image corresponding to the processed image signal on a screen.

22. The method of claim 16, wherein the controlling of the field of vision of the photographed image comprises:
forming an optical image of an external object and photoelectrically converting the optical image to an electric image signal;
receiving the camera control signal through the cable;
interfacing the received camera control signal to be recognizable by the camera; and
controlling the forming of the optical image of the external object corresponding to the camera control signal.

23. The method of claim 22, further comprising:
interfacing of the camera control signal using recommended standard RS-485.

24. The method of claim 22, further comprising:
receiving of the camera control signal through an RJ-45 module.

25. The method of claim 22, further comprising:
signal-processing and transmitting the electric image signal to a camera interface; and transmitting the processed electric image signal to the monitor through the cable.

26. The method of claim 16, further comprising:
receiving and transmitting the image signal and the power application between the camera and the monitor through an RJ-45 cable.

27. A method of operating a plurality of surveillance cameras, each camera connected to a monitor through an RJ-45 cable, the method comprising:
inputting a field of vision signal to the monitor for a designated one of the cameras, the field of vision signal comprising at least one of pan, tilt, or zoom;
determining whether the designated camera is controllable in with respect to the field of vision; and
transmitting the field of vision signal to the one camera through the RJ-45 cable, if the camera is controllable with respect to the field of vision.

28. A surveillance system, comprising:
a plurality of surveillance cameras;
a monitor having a plurality of predetermined display areas, each display area corresponding to one of the plurality of surveillance cameras, each surveillance camera connected to the monitor through an RJ-45 cable;
a remote controller which inputs a field of vision signal to the monitor for a designated one of the cameras, the field of vision signal comprising at least one of pan, tilt, or zoom;
a monitor controller which:
scans the plurality of cameras;
records a number of the plurality of cameras connected to the monitor and whether each camera is controllable with respect to the field of vision, in response to input power being applied to the monitor; and
transmits the field of vision signal to the designated camera through the RJ-45 cable, if the designated camera is controllable with respect to the field of vision.
